(19) United States
(12) Patent Application Publication
(10) Pub. No.: US 2022/0269478 A1
(43) Pub. Date: Aug. 25, 2022

(54) METHOD AND APPARATUS FOR PROVIDING VISUAL ARS (VARS) ASSOCIATED WITH ARTIFICIAL INTELLIGENCE MODULE IN SMART PHONE

(71) Applicant: iCubeOn inc., Seoul (KR)

(72) Inventor: Seungjin CHOI, Seoul (KR)

(73) Assignee: iCubeOn inc., Seoul (KR)

(21) Appl. No.: 17/379,075

(22) Filed: Jul. 19, 2021

(30) Foreign Application Priority Data
Feb. 19, 2021 (KR) 10-2021-0022403

(51) Int. Cl. G06F 3/16; G06F 16/9538; G06F 16/955; G06N 5/04; H04L 29/06; H04L 29/08

(52) U.S. Cl. CPC G06F 3/167; G06F 16/9538; G06F 16/9566; G06N 5/04; H04L 65/1069; H04L 67/02

(57) ABSTRACT

Embodiments may provide an operation method of a first terminal for automatically enabling a visual audience response system (ARS). In this instance, the operation method of the first terminal may include detecting a user search request for first content, transmitting a search result request message for the first content to a link information server based on the detected user search request, receiving search result list information related to the first content from the link information server, the search result list information including uniform resource locator (URL) information and visual ARS (VARS) related information for each search result, displaying a plurality of objects for each search result based on the received search result list information, detecting a user input for a first object among the plurality of objects, and making a call connection to a second terminal based on the detected user input.

### FIELD

Embodiments relate to a method and apparatus for providing a visual audience response system (ARS) associated with an artificial intelligence module in a smartphone. More particularly, embodiments relate to a method that searches for related content associated with an artificial intelligence module of a smartphone and provides visual ARS (VARS) based on the related content.

### BACKGROUND

Recently, with the increasing contactless services, the use of audience response system (ARS) response or automatic response for contactless services is increasing. However, since ARS response or automatic response is made based on preset selections, it may not be easy for customers using the services to acquire desired responses. By this reason, customers often acquire desired responses through call center agents instead of ARS response or automatic response, but it takes a long time to acquire desired responses due to the limited number of call center agents, so there are limitations in providing services.

More recently, smartphones have artificial intelligence modules such as SIRI or BIXBY, and there are emerging services for transmitting commands to the smartphones or searching for content based on the artificial intelligence modules. However, currently, the artificial intelligence of the smartphones only performs command control within the smartphones, so there are limitations in connecting to external servers and providing necessary information to users. Considering the above description, a method and apparatus for providing visual ARS (VARS) services associated with the artificial intelligence modules to users will be described as below.

### SUMMARY

The present disclosure relates to a method and apparatus for providing a visual audience response system (ARS) associated with an artificial intelligence module in a smartphone.

The present disclosure relates to a method and apparatus for providing visual ARS (VARS) based on a link information providing server associated with an artificial intelligence module.

The present disclosure relates to a method and apparatus for providing VARS based on a service server associated with an artificial intelligence module.

The present disclosure relates to a method for automatically enabling VARS when making a call connection based on a service associated with an artificial intelligence module.

The present disclosure relates to a method for automatically enabling VARS based on a temporary uniform resource locator (URL) based on a service associated with an artificial intelligence module.

The object of the present disclosure is not limited to the above-described object, and may be expanded to various objects that may be derived by the embodiments of the present disclosure described below.

According to an embodiment of the present disclosure, there may be provided an operation method of a first terminal for automatically enabling a visual audience response system (ARS). In this instance, the operation method of the first terminal may include detecting a user search request for first content, transmitting a search result request message for the first content to a link information server based on the detected user search request, receiving search result list information related to the first content from the link information server, the search result list information including uniform resource locator (URL) information for each search result, displaying a plurality of objects for each search result based on the received search result list information, detecting a user input for a first object among the plurality of objects, and making a call connection to a second terminal based on the detected user input. In this instance, when the call connection to the second terminal is made, visual VARS related to the second terminal corresponding to the first object may be automatically enabled based on the URL information for each search result.

Additionally, according to an embodiment of the present disclosure, when the link information server receives the search result request message for the first content from the first terminal, the link information server may identify the search result list information related to the first content based on a database of the link information server, request the URL information for each search result to a visual ARS server based on the search result list information, and receive the URL information for each search result from the visual ARS server and provide to the first terminal.

Additionally, according to an embodiment of the present disclosure, the link information server and the visual ARS server may be one service server, and the service server may identify the URL information for each search result based on the search result list information and provide the first terminal with the URL information for each search result based on the search result list information.

Additionally, according to an embodiment of the present disclosure, the first terminal may transmit location information of the first terminal to the link information server, and the search result list information may be acquired based on the location information of the first terminal.

Additionally, according to an embodiment of the present disclosure, whether it is possible to automatically enable the visual ARS may be identified for each search result based on the search result list information, and the URL information may be provided to the first terminal for only a search result capable of automatically enabling the visual ARS among the search results.

Additionally, according to an embodiment of the present disclosure, the plurality of objects for each search result may include at least one of an object which makes a connection to the second terminal, an object which identifies location information of the second terminal or an object which identifies homepage information of the second terminal.

Additionally, according to an embodiment of the present disclosure, when the call connection to the second terminal is made and the visual VARS related to the second terminal corresponding to the first object is automatically enabled based on the URL information for each search result, the call connection to the second terminal may be terminated, and the first terminal may be connected to the visual VARS server and exchange information based on the automatically enabled visual VARS.

Additionally, according to an embodiment of the present disclosure, the first terminal may include an artificial intelligence module, the first terminal may transmit a request message for registration of the link information server to an artificial intelligence server based on the artificial intelligence module, and when the first terminal receives capsule information of the link information server from the artificial intelligence server, the first terminal may transmit the search result request message for the first content based on the capsule information.

Additionally, according to an embodiment of the present disclosure, there may be provided an operation method of a link information server for performing content search of a first terminal. The operation method of the link information server for performing content search of the first terminal may include receiving a search result request message for first content from the first terminal, acquiring search result list information related to the first content based on the search result request message for the first content, requesting URL information for each search result in the search result list information to a visual ARS server based on the acquired search result list information, receiving the URL information for each search result from the visual ARS server, and transmitting the received URL information for each search result to the first terminal.

Additionally, according to an embodiment of the present disclosure, there may be provided an operation method of a visual ARS server for performing content search of a first terminal. In this instance, the operation method of the visual ARS server for performing content search of the first terminal may include receiving a URL information request for each search result in search result list information from a link information server, identifying whether it is possible to automatically enable visual ARS for each search result in the search result list information, transmitting the URL information for each search result capable of automatically enabling the visual ARS among the search results in the search result list information to the link information server, and exchanging data with the first terminal when the first terminal connected to the link information server makes a call connection to a second terminal based on the URL information for each search result.

The present disclosure may provide visual audience response system (ARS) associated with the artificial intelligence module in the smartphone.

The present disclosure may provide visual ARS (VARS) based on the link information providing server associated with the artificial intelligence module.

The present disclosure may provide VARS based on the service server associated with the artificial intelligence module.

The present disclosure may provide a service without an additional operation by automatically enabling VARS when making a call connection based on the service associated with the artificial intelligence module.

The present disclosure may automatically serve VARS without an additional operation based on a temporary uniform resource locator (URL) based on the service associated with the artificial intelligence module.

The effect of the present disclosure is not limited to the above-described effect, and may be expanded to various effects that may be derived by the embodiments of the present disclosure described below.

### BRIEF DESCRIPTION OF DRAWINGS

FIG. 1 is a diagram showing an example of an operating environment of a system according to an embodiment of the present disclosure.

FIG. 2 is a block diagram illustrating an internal configuration of a computing device 200 in an embodiment of the present disclosure.

FIG. 3 is a diagram showing a method for automatically enabling visual audience response system (VARS) based on a link information providing server in an embodiment of the present disclosure.

FIG. 4 is a diagram showing a method for automatically enabling VARS based on a service server in an embodiment of the present disclosure.

FIG. 5 is a diagram showing a method for registering a link information server to an artificial intelligence server in an embodiment of the present disclosure.

FIG. 6A is a diagram showing a method for automatically providing VARS in an embodiment of the present disclosure.

FIG. 6B is a diagram showing a method for automatically providing VARS in an embodiment of the present disclosure.

FIG. 6C is a diagram showing a method for automatically providing VARS in an embodiment of the present disclosure.

FIG. 6D is a diagram showing a method for automatically providing VARS in an embodiment of the present disclosure.

FIG. 6E is a diagram showing a method for automatically providing VARS in an embodiment of the present disclosure.

FIG. 7 is a diagram showing a method for identifying whether VARS is supported in an embodiment of the present disclosure.

FIG. 8 is a diagram showing an operation method of automatically enabled VARS in an embodiment of the present disclosure.

FIG. 9A is a diagram showing a method for executing at least one of VARS or a voice call based on a user input in an embodiment of the present disclosure.

FIG. 9B is a diagram showing a method for executing at least one of VARS or a voice call based on a user input in an embodiment of the present disclosure.

FIG. 10 is a diagram showing a method for automatically enabling VARS associated with an artificial intelligence module in an embodiment of the present disclosure.

### DETAILED DESCRIPTION OF THE EMBODIMENTS

In describing an embodiment of the present disclosure, when a certain description of well-known elements or functions is deemed to obscure the subject matter of an embodiment of the present disclosure, its detailed description is omitted herein. Additionally, in the drawings, elements irrelevant to the description of an embodiment of the present disclosure are omitted herein, and like reference signs are affixed to like elements.

In an embodiment of the present disclosure, when an element is referred to as being “connected”, “coupled” or “linked” to another element, this may include not only a direct connection relationship but also an indirect connection relationship in which intervening elements are present. Additionally, unless expressly stated to the contrary, “comprise” or “include” when used in this specification, specifies the presence of stated elements but does not preclude the presence or addition of one or more other elements.

In an embodiment of the present disclosure, the terms “first”, “second” and the like are used to distinguish an element from another, and do not limit the order or importance between elements unless otherwise mentioned. Accordingly, a first element in an embodiment may be referred to as a second element in other element within the scope of embodiments of the present disclosure, and likewise, a second element in an embodiment may be referred to as a first element in other embodiment.

In an embodiment of the present disclosure, the distinguishable elements are intended to clearly describe the feature of each element, and do not necessarily represent the separated elements. That is, a plurality of elements may be integrated into one hardware or software, and an element may be distributed to multiple hardware or software. Accordingly, although not explicitly mentioned, the integrated or distributed embodiment is included in the scope of embodiments of the present disclosure.

In the specification, a network may be a concept including a wired network and a wireless network. In this instance, the network may be a communication network that allows data exchange between a device and a system and between devices, and is not limited to a particular network.

The embodiment described herein may have aspects of entirely hardware, partly hardware and partly software, or entirely software. In the specification, “unit”, “apparatus” or “system” refers to a computer related entity such as hardware, a combination of hardware and software, or software. For example, the unit, module, apparatus or system as used herein may be a process being executed, a processor, an object, an executable, a thread of execution, a program and/or a computer, but is not limited thereto. For example, both an application running on a computer and the computer may correspond to the unit, module, apparatus or system used herein.

Additionally, the device as used herein may be a mobile device such as a smartphone, a tablet PC, a wearable device and a Head Mounted Display (HMD) as well as a fixed device such as a PC or an electronic device having a display function. Additionally, for example, the device may be an automotive cluster or an IoT (Internet of Things) device. That is, the device as used herein may refer to devices on which an application can run, and is not limited to a particular type. In the following description, for convenience of description, a device on which an application runs is referred to as the device.

In the present disclosure, there is no limitation in the communication method of the network, and a connection between each element may not be made by the same network method. The network may include a communication method using a communication network (for example, a mobile communication network, a wired Internet, a wireless Internet, a broadcast network, a satellite network, etc.) as well as near-field wireless communication between devices. For example, the network may include all communication methods that enable networking between objects, and is not limited to wired communication, wireless communication, 3G, 4G, 5G, or other methods. For example, the wired and/or wireless network may refer to a communication network by at least one communication method selected from the group consisting of Local Area Network (LAN), Metropolitan Area Network (MAN), Global System for Mobile Network (GSM), Enhanced Data GSM Environment

(EDGE), High Speed Downlink Packet Access (HSDPA), Wideband Code Division Multiple Access (W-CDMA), Code Division Multiple Access (CDMA), Time Division Multiple Access (TDMA), Bluetooth, Zigbee, Wi-Fi, Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) or communication using ultrasonic waves, but is not limited thereto.

The elements described in a variety of embodiments are not necessarily essential, and some elements may be optional. Accordingly, an embodiment including some of the elements described in the embodiment is also included in the scope of embodiments of the present disclosure. Additionally, in addition to the elements described in a variety of embodiments, an embodiment further including other elements is also included in the scope of embodiments of the present disclosure.

Hereinafter, the embodiments of the present disclosure will be described in detail with reference to the accompanying drawings.

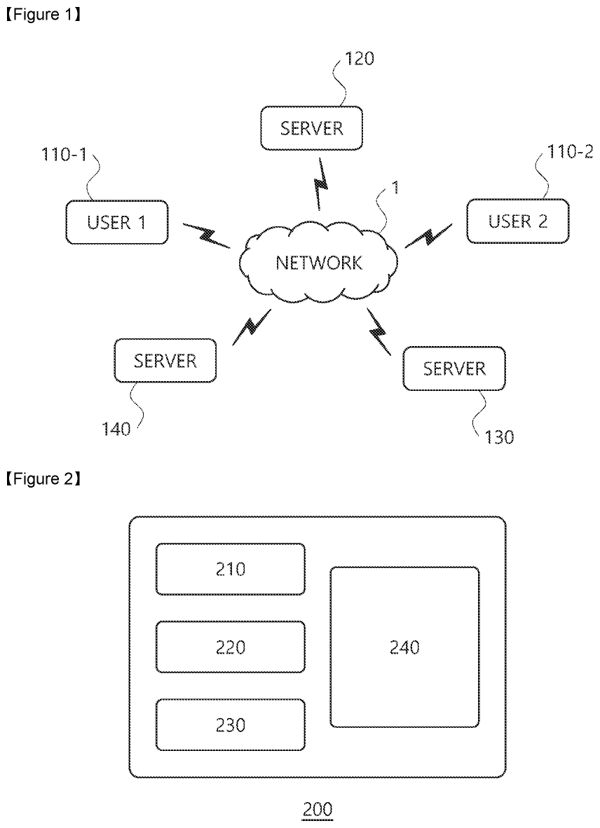

FIG. 1 is a diagram showing an operating environment of a system according to an embodiment of the present disclosure. Referring to FIG. 1, a user device 110 and at least one server 120, 130, 140 are connected via a network 1. FIG. 1 shows an example for explanation of the present disclosure, and the number of user devices or servers is not limited to FIG. 1.

The user device 110 may be a fixed or mobile terminal implemented as a computer system. The user device 110 may include, for example, a smartphone, a mobile phone, a navigation, a computer, a laptop computer, a terminal for digital broadcast, a Personal Digital Assistant (PDA), a Portable Multimedia Player (PMP), a tablet PC, a game console, a wearable device, an internet of things (IoT) device, a virtual reality (VR) device and an augmented reality (AR) device. For example, in embodiments, the user device 110 may substantially refer to one of a variety of physical computer systems that can communicate with the servers 120-140 via the network 1 using a wireless or wired communication method.

Each server may be implemented as a computer device or a plurality of computer devices capable of providing commands, code, files, content and services by communication with the user device 110 via the network 1. For example, the server may be a system that provides each service to the user device 110 having accessed via the network 1. In a more specific example, the server may provide an intended service (for example, information provision) of an application as a computer program installed and running on the user device 110 to the user device 110 through the corresponding application. In another example, the server may distribute a file for installing and running the above-described application to the user device 110, receive user input information and provide a corresponding service. For example, a link information server, a visual ARS server and a service server as described below may be one of the servers of FIG. 1, and the other servers may be one of the servers of FIG. 1. Additionally, a user terminal and a business owner terminal may be one of the users of FIG. 1, and the other terminals may be one of the users of FIG. 1. That is, each terminal and each server may operate in a manner of performing communication and exchanging data via a network, and is not limited to the above-described embodiment.

FIG. 2 is a block diagram illustrating an internal configuration of a computing device 200 in an embodiment of the present disclosure. The computing device 200 may be applied to the at least one user device 110-1, 110-2 or the server 120-140 described above with reference to FIG. 1, and each device and each server may have identical or similar internal components by adding or removing some components.

Referring to FIG. 2, the computing device 200 may include a memory 210, a processor 220, a communication module 230 and a transmitter/receiver 240. The memory 210 is a non-transitory computer-readable recording medium, and may include a non-volatile mass storage device such as random access memory (RAM), read only memory (ROM), disk drive, solid state drive (SSD) and flash memory. Here, the non-volatile mass storage device such as ROM, SSD, flash memory and disk drive is a separate permanent storage device that is different from the memory 210, and may be included in the device or server. Additionally, the memory 210 may store an operating system and at least one program code (for example, code for the application installed in the user device 110 to provide a browser or a specific service installed and running on the user device 110). These software components may be loaded from a separate computer-readable recording medium other than the memory 210. The separate computer-readable recording medium may include a computer-readable recording medium such as a floppy drive, a disc, a tape, a DVD/CD-ROM drive and a memory card.

In another embodiment, the software components may be loaded on the memory 210 through the communication module 230, not the computer-readable recording medium. For example, at least one program may be loaded on the memory 210 based on a computer program (for example, the above-described application) installed by files provided via the network 1 by developers or distributed file systems (for example, the above-described servers) which distribute application installer files.

The processor 220 may be configured to process the instructions of the computer program by performing the basic computation, logic and input/output calculation. The instructions may be provided to the processor 220 by the memory 210 or the communication module 230. For example, the processor 220 may be configured to execute the received instructions according to the program code stored in a recording device such as the memory 210.

The communication module 230 may provide a function for communication between the user device 110 and the server 120-140 via the network 1, and may provide a function for communication between each of the device 110 and/or the server 120-140 and other electronic device.

The transmitter/receiver 240 may be a means for interfacing with an external input/output device (not shown). For example, the external input device may include a keyboard, a mouse, a microphone and a camera, and the external output device may include a display, a speaker and a haptic feedback device. In another example, the transmitter/receiver 240 may be a means for interfacing with a device having an integrated function for input and output such as a touch screen.

Additionally, in another embodiment, the computing device 200 may include more components than the components of FIG. 2 according to the properties of a device to which it is applied. For example, when the computing device 200 is applied to the user device 110, the computing device 200 may include at least some of the above-described input/output devices, or may further include a transceiver, a Global Positioning System (GPS) module, a camera, various types of sensors and a database. In a more specific example, when the user device is a smartphone, the computing device 200 may further include a variety of components commonly included in the smartphone such as an acceleration sensor or a gyro sensor, a camera module, various types of physical buttons, buttons using a touch panel, an input/output port and a vibrator for vibration.

In the following description, each terminal and each server may be a device that performs communication with other terminal or server based on FIG. 2. That is, the terminal and server described below may be subjects that are connected to each other and perform communication via a network based on FIG. 1, and each terminal and server may be a computing device that operates, including the memory, the processor, the communication module and the transmitter/receiver based on FIG. 2 and other configuration. Although the following description is made based on the terminal and server for convenience of description, the above-described components may include various components as the computing device, and may be not limited to a particular computing device.

For example, for an existing smartphone to provide audience response system (ARS) response (or automatic response), a voice call (or an audio call) may be received, and a service may be provided based on a predefined item through an ARS response server. That is, when the business owner terminal receives a voice call (or an audio call) from the user terminal, the business owner terminal may request uniform resource locator (URL) and ARS information to the ARS response server, and receive the URL and ARS information and provide it to the user terminal.

In this instance, for example, URL and related information for visual ARS (VARS) may be automatically enabled based on an artificial intelligence module of the smartphone and the visual ARS server before the voice call (or the audio call) is received by the business owner terminal, and VARS may be automatically provided based on the information when the user's voice call (or the audio call) is received, thereby increasing user accessibility, and its description will be provided.

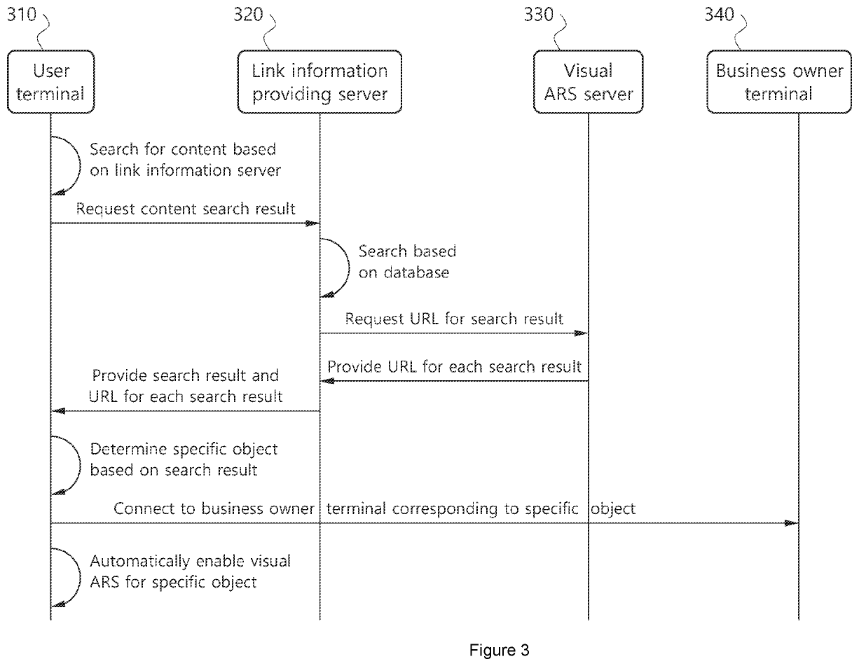

FIG. 3 is a diagram showing a method for automatically enabling VARS based on the link information providing server in an embodiment of the present disclosure.

Referring to FIG. 3, the user terminal 310 may perform a content search based on the link information providing server 320. For example, the user terminal 310 includes an artificial intelligence module, and the link information providing server 320 may be registered in the artificial intelligence module. For example, the link information providing server 320 may be registered in the artificial intelligence module of the user terminal 310 based on an artificial intelligence server, and it will be described below.

When the user terminal 310 searches for content based on the link information providing server 320 registered based on the artificial intelligence module, the user terminal 310 may transmit a content search result request message to the link information providing server 320. For example, when the user terminal 310 searches for content in a webpage or the user terminal 310 without the link information providing server 320, it may not be easy to derive the user's desired search result. For example, in case that content the user terminal 310 intends to search is related to an operation of making connection based on telephone number or identification information, when the user terminal 310 performs a content search without the link information providing server 320, lots of unnecessary information may be included and efficient search may fail. Accordingly, the user terminal 310 may search for content based on the link information providing server 320. For example, the link information providing server 320 may be may be a server that provides company information through the telephone number or other identification information based on call records, but may be not limited thereto.

Subsequently, the link information providing server 320 may search for content through the database based on the request from the user terminal 310. The link information providing server 320 may search for corresponding company or content information based on the telephone number or other identification information, and derive a result. Here, the user terminal 310 may further transmit location information of the user terminal 310 to the link information providing server 320. The link information providing server 320 may derive a search result using the location information received from the user terminal 310. For example, the link information providing server 320 may derive related content based on the telephone number or other identification information, and derive only information within a preset distance as the result based on the location information of the user terminal 310. In a more specific example, the user terminal 310 may request restaurant information as content information to the link information providing server 320. The link information providing server 320 may derive a result related to the restaurant based on the restaurant telephone number or other identification information. Additionally, for example, the link information providing server 320 may reflect the location information of the user terminal 310 in the related restaurant result and derive restaurant information within a predetermined distance as the result from the user terminal 310.

Subsequently, the link information providing server 320 may request URL information or other VARS related information for each search result to the visual ARS server 330 based on the derived search result. In this instance, the visual ARS server 330 may generate URL information or other VARS related information for each search result and transmit it to the link information providing server 320.

In the specification, the URL information may refer to a webpage address connected to the caller's call to provide visual ARS. That is, the URL information may be a web address used for the caller to connect to a visual ARS service provided by a callee. In other words, the URL information may be a temporary/non-temporary web address dedicated to the caller for visual ARS.

Additionally, the VARS related information includes all information for providing visual ARS. For example, the VARS related information may be text or voice information for automatic response, or multimedia information that makes up a webpage. Alternatively, the VARS related information may be URL for connection to a third server, and the third server may include an artificial intelligence module for automatic response.

In an embodiment, the visual ARS server 330 may temporarily or non-temporarily generate URL information or other VARS related information for each search result based on the above-described request. For example, the visual ARS server 330 may generate the URL information and/or the VARS related information using an identifier (for example, telephone number or identification cod) used to identify the user terminal 310 from the link information providing server 320. For example, for companies derived as the search result, URL for providing visual ARS may be pre-prepared. Although only one of the search results is selected by the user of the user terminal, URL for visual ARS of possibly selected companies (listed as the search result) may be pre-transmitted to the user terminal.

In an example, the URL information or other VARS related information for each search result may be information based on the content search of the user terminal 310. Additionally, for example, the visual ARS server 330 may transmit only information of the registered content or company to the link information providing server 320. For example, the visual ARS server 330 may determine whether it is possible to provide information based on each requested search result. That is, each search result may be each content, and the visual ARS server 330 may determine whether it is possible to provide information for each content.

The visual ARS server 330 may determine whether it is possible to provide information for each search result, and provide the URL information or VARS related information of content (or company) possible to provide information for each search result. Additionally, with regard to content impossible to provide information, the visual ARS server 330 may transmit information impossible to provide to the link information providing server 320. For example, the visual ARS server 330 may generate a list of content impossible to provide information, and transmit list information to the link information providing server 320. Subsequently, the link information providing server 320 may transmit the URL information or VARS information for each search result to the user terminal 310. Additionally, for example, the link information providing server 320 may provide a list of content impossible to provide information to the user terminal 310. Subsequently, the user terminal 310 may determine a specific object (or a specific content, or a specific business) based on the search result, and make a connection to the business owner terminal 340 corresponding to the determined specific object. For example, the connection may be a voice call (or an audio call) connection.

Additionally, for example, the connection may be a connection based on data communication, and is not limited to the above-described embodiment. In this instance, the business owner terminal 340 may automatically receive the connection of the user terminal 310. Here, since the user terminal 310 pre-acquired the URL information or VARS information of the specific object based on the above description, the business owner terminal 340 may not request the URL information to the visual ARS server 330 or other server. That is, when the business owner terminal 340 automatically receives the connection of the user terminal 310, the user terminal 310 may automatically enable VARS based on the URL information or VARS information and provide it to the user. In this instance, when VARS is automatically enabled, the connection to the business owner terminal 340 may be terminated. In another example, even though VARS is automatically enabled, the connection to the business owner terminal 340 is not terminated and is maintained, and voice guidance may start through an automatic response server. In still another example, as VARS is automatically enabled, the voice call connection to the business owner terminal 340 may be completed to make a call with the user of the business owner terminal 340, and is not limited to the above-described embodiment.

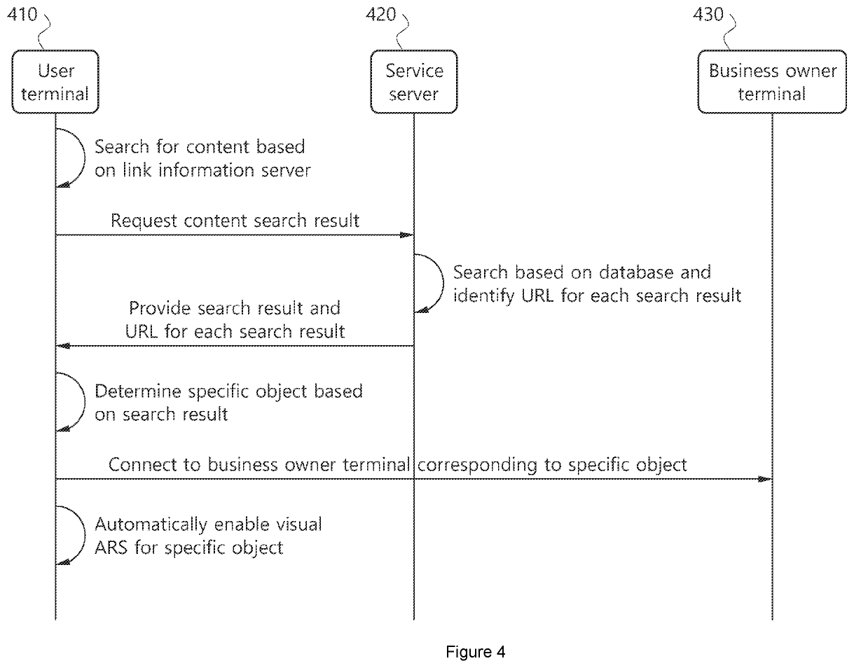

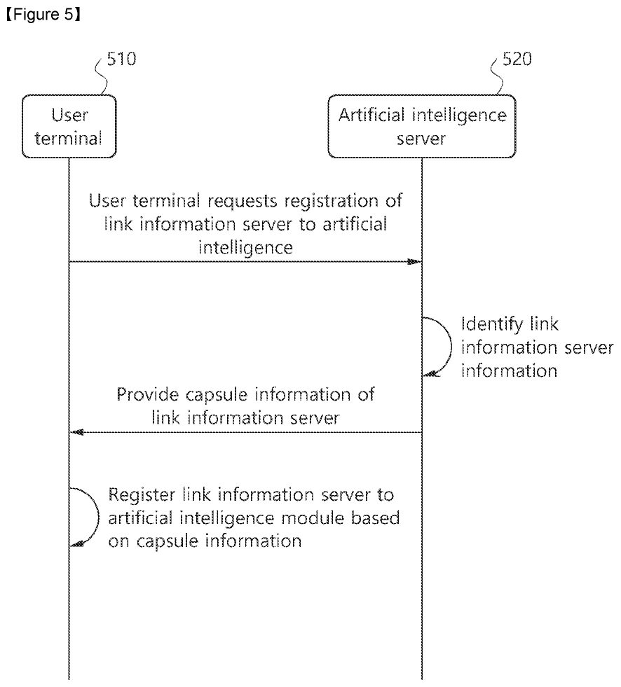

In another example, in FIG. 4, in an embodiment of the present disclosure, VARS may be automatically enabled based on the service server. For example, the service server may be an integrated server of the automatic connection providing server and the visual ARS server of FIG. 3. More specifically, referring to FIG. 4, the user terminal 410 may perform a content search based on the service server 420. For example, the user terminal 410 includes an artificial intelligence module, and the service server 420 may be registered in the artificial intelligence module. For example, the service server 420 may be registered in the artificial intelligence module of the user terminal 410 based on an artificial intelligence server, and its description will be provided.

When the user terminal 410 searches for content based on the service server 420 registered based on the artificial intelligence module, the user terminal 410 may transmit a content search result request message to the service server 420. For example, when the user terminal 410 searches for content in a webpage or the user terminal 410 without the service server 420, it may not be easy to derive the user's desired search result.

For example, in case that content the user terminal 410 intends to search is related to an operation of making connection based on telephone number or identification information, when the user terminal 410 performs a content search without the service server 420, lots of unnecessary information may be included, and efficient search may fail. That is, when the user terminal 410 searches for content based on all information, it may not easy to derive the user's desired search result, so the user terminal 410 may search for content based on the service server 420. For example, the service server 420 may be a server that provides company information through the telephone number or other identification information based on call records, and may be a server that acquires URL information to provide visual ARS.

Subsequently, the service server 420 may search for content through the database based on the request of the user terminal 410. For example, the service server 420 may search for corresponding company or content information based on the telephone number or other identification information, and derive a result. Here, for example, the user terminal 410 may further transmit location information of the user terminal 410 to the service server 420. The service server 420 may derive a search result using the location information received from the user terminal 410. For example, the service server 420 may derive the related content based on the telephone number or other identification information, and derive only information within a preset distance based on the location information of the user terminal 410. In a more specific example, the user terminal 410 may request restaurant information as content information to the service server 420. The service server 420 may derive a result related to the restaurant based on the restaurant telephone number or other identification information. Additionally, for example, the service server 420 may reflect the location information of the user terminal 410 in the related restaurant result and derive restaurant information within a predetermined distance as the result from the user terminal 410.

Subsequently, the service server 420 may generate URL information or other VARS related information based on the derived search result. In this instance, the service server 420 may temporarily generate the URL information or other VARS related information for each search result. That is, the URL information or other VARS related information for each search result may be one-time information but is not limited thereto. Here, the URL information for each search result may be related to a webpage address capable of providing visual ARS between the company as each search result and the user terminal. The service server 420 may pre-allocate URL for visual ARS to the company derived as the search result and provide it to the user terminal together with the search result.

Additionally, for example, the service server 420 may generate information of the registered content or company. For example, the service server 420 may determine whether it is possible to provide information based on each requested search result. That is, each search result may be each content, and the service server 420 may determine whether it is possible to provide information for each content.

The service server 420 may determine whether it is possible to provide information for each search result, and with regard to content (or company) possible to provide information, may generate URL information or VARS related information for each search result. Additionally, with regard to content impossible to provide information, the service server 420 may generate information impossible to provide. For example, the service server 420 may generate a list of content impossible to provide information. Subsequently, the service server 420 may transmit the URL information or VARS information for each search result to the user terminal 410. Additionally, for example, the service server 420 may provide a list of content impossible to provide information to the user terminal 410. For example, the service server 420 may provide information for the user terminal to distinguishably display a company to which visual ARS automatic connection is possible and a company to which visual ARS automatic connection is impossible. There may be business owners (referred to as companies or search results) who subscribed to a URL allocation and providing service for providing visual ARS and did not subscribe the service. The service server may provide a business owner who did not subscribe to the service as the search result to the user terminal, and when providing, may distinguishably display a company which supports visual ARS and a company which does not support visual ARS. Since there is a high possibility that the user will connect to a company which supports visual ARS in such a situation, the use of visual ARS will be helpful for business owners.

Subsequently, the user terminal may determine a specific object (or a specific content or a specific business) based on the search result, and make a connection to the business owner terminal 430 corresponding to the determined specific object. For example, the connection may be a voice call (or an audio call) connection. Additionally, for example, the connection may be a connection based on data communication, and is not limited to the above-described embodiment. In this instance, the business owner terminal 430 may automatically receive the connection of the user terminal 410. Here, since the user terminal 410 pre-acquired the URL information or VARS information of the specific object based on the above description, the business owner terminal 430 may not request the URL information to the service server 420 or other server. That is, when the business owner terminal 430 automatically receives the connection of the user terminal 410, the user terminal 410 may automatically enable VARS based on the URL information or VARS information and provide it to the user. In this instance, when VARS is automatically enabled, the connection to the business owner terminal 430 may be terminated. In another example, even though VARS is automatically enabled, the connection to the business owner terminal 430 is not terminated and is maintained, and voice guidance may start through an automatic response server. In still another example, as VARS is automatically enabled, the voice call connection to the business owner terminal 430 may be completed to make a call with the user of the business owner terminal 430, and is not limited to the above-described embodiment.

FIG. 5 is a diagram showing a method for registering the link information server to the artificial intelligence server in an embodiment of the present disclosure.

As described above, the user terminal 510 may register the link information server to the artificial intelligence server 520. In this instance, the user terminal 510 may transmit a message for registration of the link information server to the artificial intelligence server 520. For example, although FIG. 5 is shown on the basis of the link information server, it may be equally applied to the service server of FIG. 4, and is not limited to the above embodiment. When the artificial intelligence server 520 receives the request message for registration of the link information server from the user terminal 510, the artificial intelligence server 520 may identify link information server information. Subsequently, the artificial intelligence server 520 may identify capsule information of the link information server and transmit it to the user terminal 510. Here, the capsule information of the link information server may be the result of encapsulation of information needed for the user terminal 510 to associate instructions or other information related to the link information server through the artificial intelligence module. The user terminal 510 may register the link information server to the artificial intelligence module based on the capsule information, make a connection to the link information server based on the user's voice command or other information, provide URL information or VARS related information of content through content search as shown in FIG. 3 or 4, and automatically enable VARS for the selected specific object.

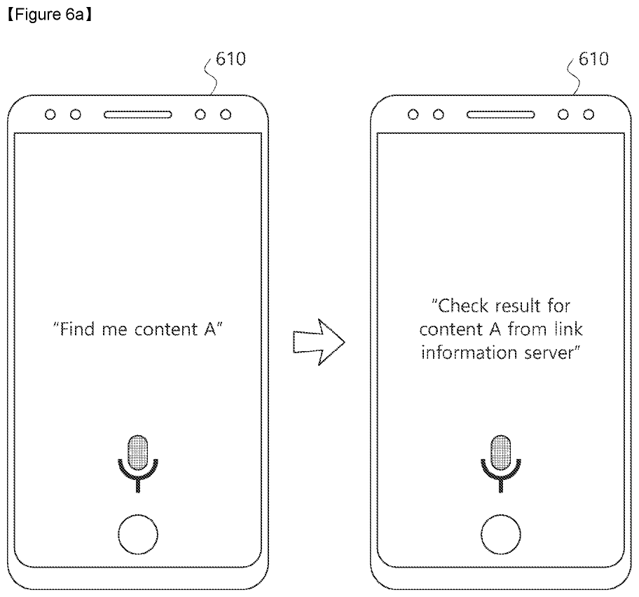

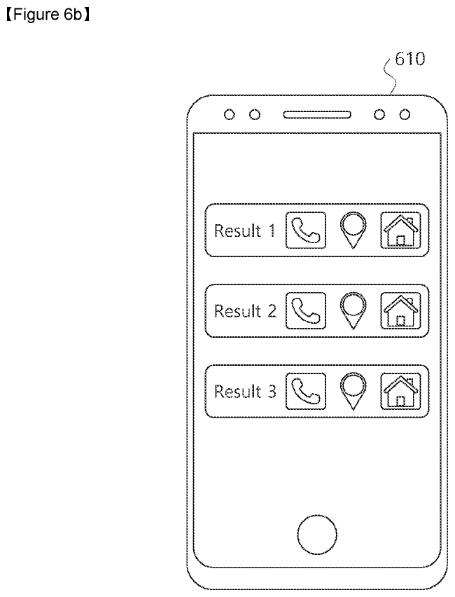

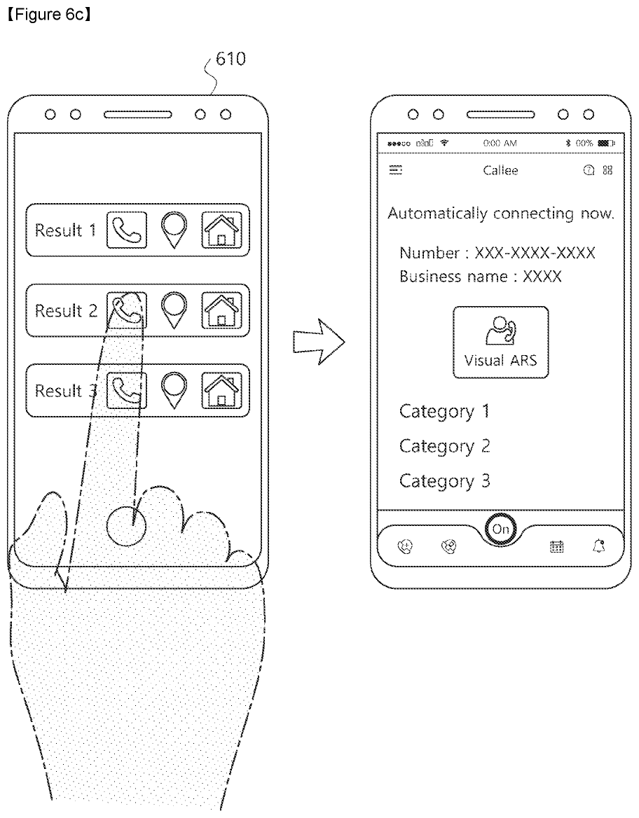

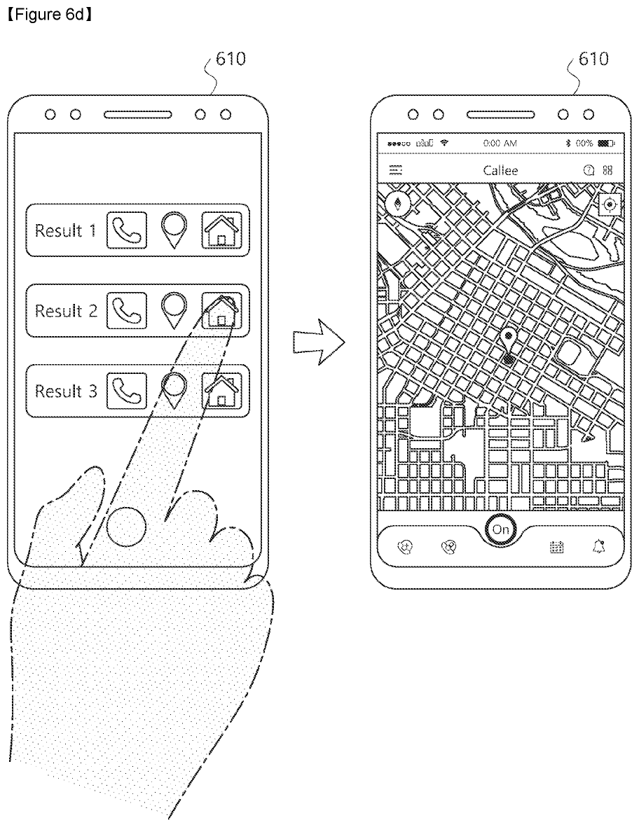

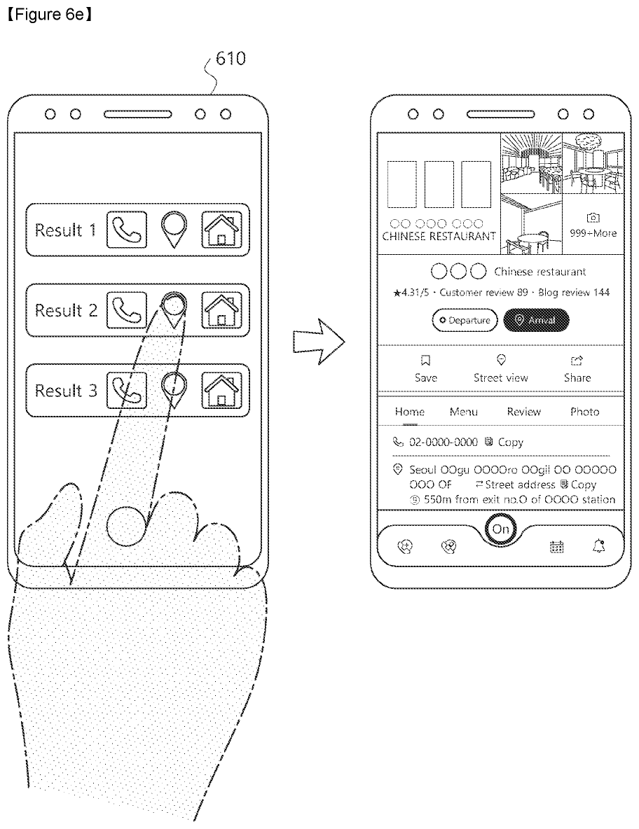

FIGS. 6A to 6E are diagrams showing a method for automatically providing VARS in an embodiment of the present disclosure. For example, referring to FIG. 6A, the user terminal 610 may detect a user input through the artificial intelligence module. For example, as shown in FIG. 5, the artificial intelligence module may have registered the link information server (or the service server) through the capsule information based on the artificial intelligence server, and may perform a search through the user input in the registered link information server (or the service server). In a specific example, when the user input is “find me content A”, the user terminal 610 may identify a search command for content A based on the artificial intelligence module, and through this, identify a result for content A from the link information server. In a more specific example, the user terminal 610 may receive the user's command to request a search for restaurant telephone number, and acquire related information in the link information server based on the restaurant name or identification information. Subsequently, referring to FIG. 6B, the user terminal 610 may acquire search result information related to content A from the link information server and display it. Here, the search result information may be each information related to content A. For example, in the case of restaurant search, a restaurant list related to the corresponding restaurant may be provided as the search result information. Here, the link information server may request URL information or VARS related information for each search result information to the VARS server, and receive its information. For example, the service server itself may generate URL information or VARS related information for each search result information. Additionally, for example, each search result information may be the result of deriving search result information based on location information of the user terminal 610 and acquiring related URL information or VARS related information as described above.

Subsequently, the user terminal 610 may acquire URL information or VARS related information for each search result information from the link information server (or the service server), and display its information and provide to the user.

In this instance, referring to FIG. 6C, when the user terminal 610 detects the user's input for the specific object based on the search result, the user terminal 610 may automatically enable VARS. For example, the input of the user terminal 610 may be an input for requesting a call connection to the business owner terminal based on the search result information. That is, the input of the user terminal 610 may be an input for making a call connection to the business owner terminal corresponding to the specific object. In this instance, the user terminal 610 may automatically enable VARS based on the URL information or VARS information acquired from the link information server (or the service server). In this instance, after the user terminal 610 automatically enables VARS, the user terminal 610 may automatically terminate the call connection to the business owner terminal and provide a service through VARS. Additionally, for example, VARS may be automatically enabled by making a voice response through the automatic response server while maintaining the call connection between the user terminal 610 and the business owner terminal. In another example, the voice call (or the audio call) may be connected and made based on the call connection between the user terminal 610 and the business owner terminal, and is not limited to the above-described embodiment.

Here, for example, the user input may be different. More specifically, a call connection to the business owner terminal corresponding to specific search result information based on the specific object may be attempted as shown in FIG. 6C, and as described above, VARS may be automatically enabled. Additionally, for example, location information of the business owner corresponding to the specific search result information based on the specific object may be displayed as shown in FIG. 6D. Additionally, for example, homepage information or related information of the business owner corresponding to the specific search result information based on the specific object may be displayed as shown in FIG. 6E. Here, the above-described call connection, location information and homepage information may be provided for each search result information, and through this, various information may be provided to the user.

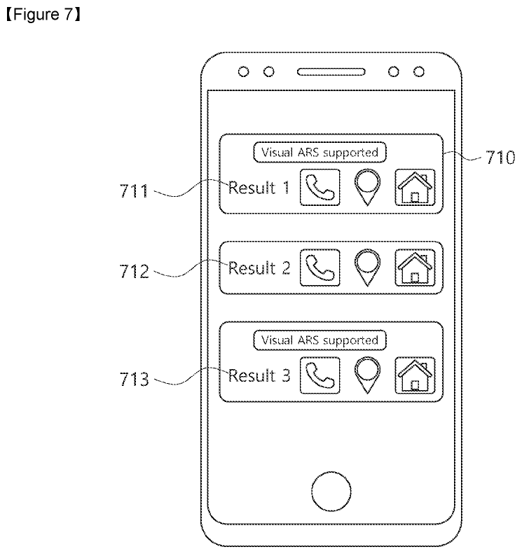

Additionally, for example, FIG. 7 is a diagram showing a method for identifying whether VARS is supported in an embodiment of the present disclosure. As described above, when the user terminal 710 acquires URL information or VARS related information based on each search result information, VARS may be automatically displayed for some of the search result information. More specifically, the link information server may acquire URL information and VARS related information from the VARS server. Additionally, the service server itself may generate URL information and VARS related information. However, for example, the URL information and VARS information may be provided only when a consent to provide information is pre-acquired from the business owner terminal for each business owner terminal. That is, the link information server (or the service server) may not provide the URL information and VARS related information for each of all search result information to the user terminal 710, and may provide information of only some objects. Considering the above description, when the user terminal 710 receives each search result information from the link information server (or the service server), the user terminal 710 may identify the presence or absence of URL information and VARS related information for each search result information. For example, the user terminal 710 may acquire the URL information and VARS related information from the link information server (or the service server) for Result 1 711 and Result 3 713 as each search result information, and may not acquire the URL information and VARS related information for Result 2 712. That is, the user terminal 710 may not automatically enable VARS for the search result corresponding to Result 2 712. In this instance, the user terminal 710 may display whether VARS is automatically enabled for Result 1 to Result 3 711, 712, 713 as each search result information while displaying the search result. Here, when the user terminal 710 makes a call connection based on Result 1 711 or Result 3 713, the user terminal 710 may automatically enable VARS. In contrast, when the user terminal 710 makes a call connection based on Result 2 712, VARS may not be automatically enabled, and only call connection may be made.

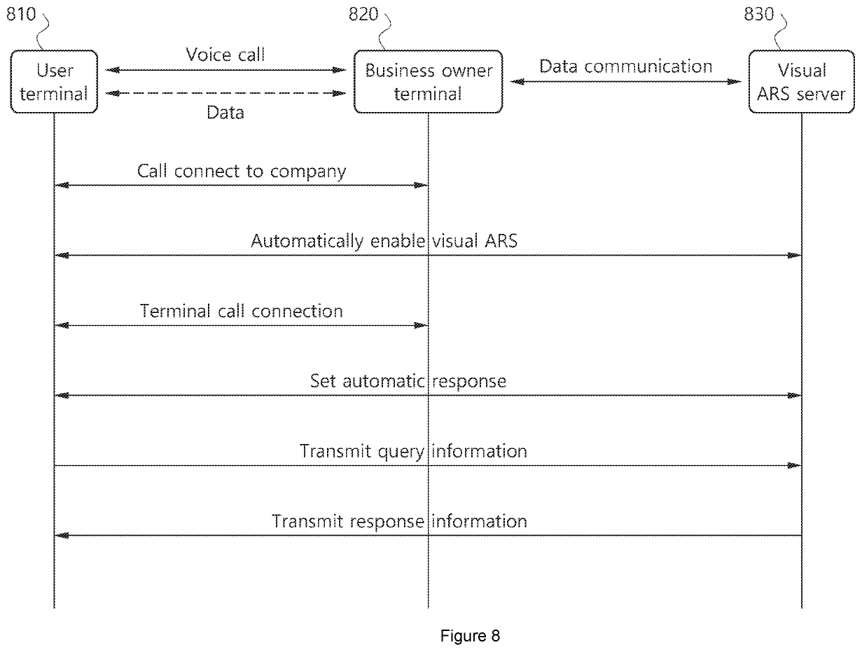

FIG. 8 is a diagram showing an operation method of automatically enabled VARS in an embodiment of the present disclosure. Referring to FIG. 8, when the user terminal 810 receives a voice call (or an audio call) to the business owner terminal 820, the user terminal 810 may attempt the voice call to the business owner terminal 820 based on identification information (e.g., telephone number). For example, the user terminal 810 and the business owner terminal 820 may perform data communication between each other and exchange data, and is not limited to the above-described embodiment. Additionally, as described above, the business owner terminal 820 and the VARS server 830 (or the service server) may have been connected to each other and exchange VARS related information. Additionally, for example, the business owner terminal 820 and the VARS server 830 (or the service server) may be continuously connected to each other and perform data communication, and is not limited to the above-described embodiment.

Here, as described above, when the user terminal 810 makes a call connection to the business owner terminal 820 based on the URL information and VARS related information provided based on the link information server (or the service server) based on the artificial intelligence module as described above, VARS may be automatically enabled. Here, for example, the call connection (the audio call) between the user terminal 810 and the business owner terminal 820 is terminated, and an automatic response may be set based on the VARS server 830 (or the service server). That is, the user terminal 810 may be connected to the VARS server 830 (or the service server), and may exchange necessary information in real time through the VARS server 830. For example, the user terminal 810 may transmit query information to the VARS server 830 (or the service server), and the VARS server 830 (or the service server) may transmit response information to the user terminal 810 based on information pre-acquired from the business owner terminal 820, and is not limited to the above-described embodiment.

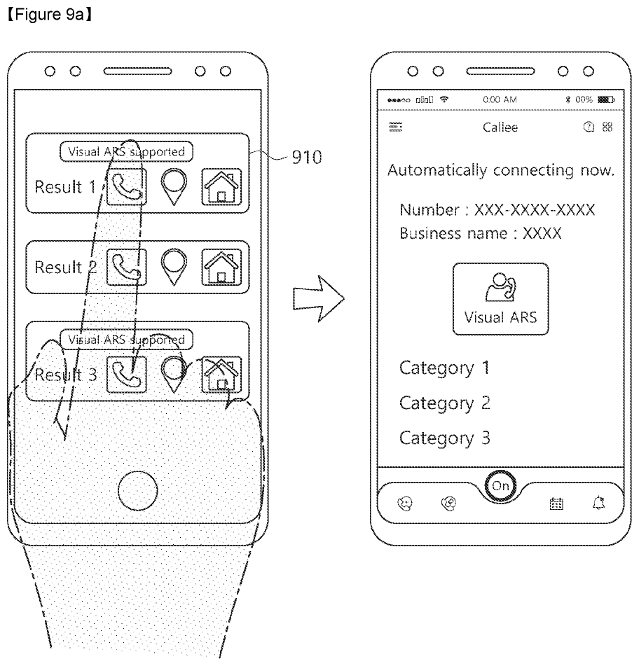

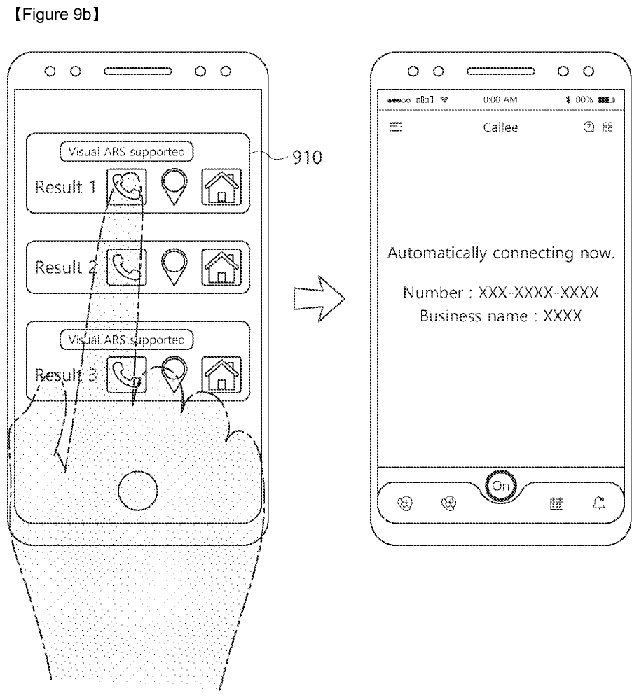

Additionally, for example, FIGS. 9A and 9B are diagrams showing a method for executing at least one of the VARS or the voice call based on the user input in an embodiment of the present disclosure. For example, the user of the user terminal 910 may select at least one of receiving a service based on VARS or automatically connecting to the business owner terminal. Referring to FIG. 9A, when the user terminal 910 receives the user input for automatically enabling VARS, the user terminal 910 may automatically enable VARS while making a call connection to the business owner terminal. In contrast, referring to FIG. 9B, when the user terminal 910 receives the user input for making a call connection to the business owner terminal, the user terminal 910 does not enable VARS, and may make a call connection to the business owner terminal. That is, the user terminal 910 may selectively proceed with automatically enabling VARS, and through this, reflect the user intent.

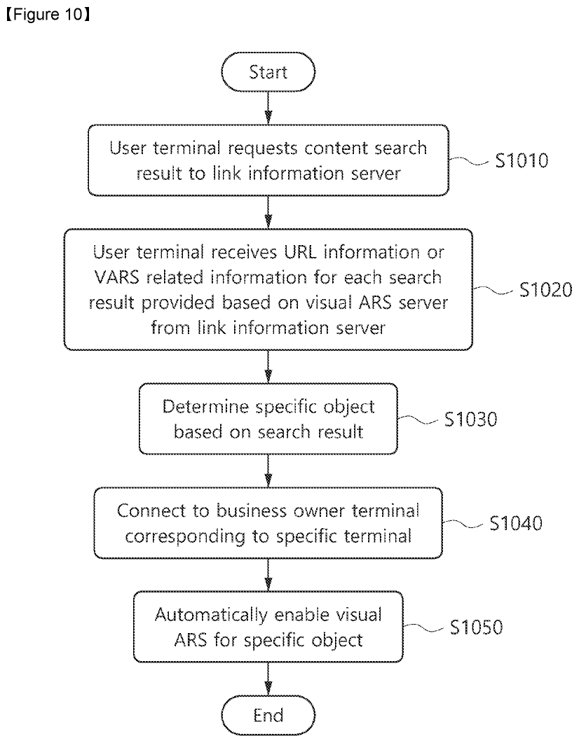

FIG. 10 is a diagram showing a method for automatically enabling VARS associated with the artificial intelligence module in an embodiment of the present disclosure.

Referring to FIG. 10, the user terminal may request a content search result to the link information server (S1010). In this instance, as described above, the user terminal includes the artificial intelligence module, and may register the link information server based on the artificial intelligence module and request the content search result as described above. Subsequently, the user terminal may acquire URL information or VARS related information for each search result provided based on the VARS server from the link information server (S1020). For example, the VARS server and the link information server may be a service server as one server, and may be the same as FIG. 4 described above. Subsequently, the user terminal may determine a specific object based on each received search result (S1030). Here, the specific object may exist for each search result, and the specific object may be at least one of an object that makes a connection to the business owner terminal, an object that identifies location information or an object that identifies homepage information as described above. In this instance, when the user terminal detects a user input for the specific object that makes a call connection to the business owner terminal, the user terminal may determine the specific object, and make a call connection to the corresponding business owner terminal (S1040). In this instance, the user terminal may automatically enable VARS for the specific object based on the URL information and VARS related information acquired from the above-described VARS server (or the service server) (S1050). In this instance, the call connection to the business owner terminal may be terminated, and the user terminal may acquire related information from the VARS server (or the service server) based on VARS as described above. In another example, the call connection to the business owner terminal may be maintained, and is not limited to the above-described embodiment.

For example, there may be an operation method of a first terminal for automatically enabling VARS. Here, the first terminal may be the above-described user terminal. In this instance, the first terminal may detect a user search request for first content. That is, the first terminal may detect a user input for searching for the first content. Here, the first content may be content which may be searched based on the telephone number or identification information based on the link information server as described above. Here, the first terminal may transmit a search result request message for the first content to the link information server based on the detected user search request, and receive search result list information related to the first content from the link information server. In this instance, the search result list information may include URL information and VARS related information for each search result. Additionally, for example, the first terminal may receive only a search result possible to automatically enable VARS among the search results in the search result list information, and is not limited to the above-described embodiment.

Subsequently, the first terminal may display a plurality of objects for each search result based on the received search result list information, and detect the user input for a first object among the plurality of objects. That is, the user may perform an operation of selecting the specific object to make a call connection to a second terminal. Here, the second terminal may be the above-described business owner terminal. When the first terminal makes a call connection to the second terminal, the first terminal may automatically enable visual VARS related to the second terminal based on the URL information and VARS related information for each search result.

Here, for example, the link information server may receive the search result request message for the first content from the above-described first terminal. In this instance, the link information server may acquire the search result list information related to the first content based on the search result request message for the first content, and request the URL information and VARS related information for each search result in the search result list information to the visual ARS server based on the acquired search result list information. In this instance, visual ARS server may transmit the URL information and VARS related information for each search result to the link information server based on whether VARS is automatically enabled, and the link information server may transmit the received URL information and VARS related information for each search result to the first terminal.

Additionally, the visual ARS server may receive the URL information and VARS related information request for each search result in the search result list information from the link information server, identify whether visual ARS can be automatically enabled for each search result in the search result list information, and transmit the URL information and VARS related information for each search result capable of automatically enabling visual ARS among the search results in the search result list information to the link information server.

Subsequently, when the first terminal connected to the link information server makes a call connection to the second terminal based on the URL information and VARS related information for each search result, a visual ARS service may be provided through data exchange with the first terminal as described above.

The embodiments described above may be, at least in part, implemented as a computer program and recorded in a computer-readable recording medium. The computer-readable recording medium includes any type of recording device that records the program for implementing the embodiments and stores computer-readable data. Examples of the computer-readable recording medium include ROM, RAM, CD-ROM, magnetic tape, optical data storage devices. Additionally, the computer-readable recording medium is distributed over computer systems connected via a network, and may store and execute the computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments shown in the drawings, this is provided for illustration purposes only and it will be appreciated by those having ordinary skill in the art that various modifications and variations may be made thereto. However, it should be noted that such modifications fall in the technical protection scope of the present disclosure. Therefore, the true technical protection scope of the present disclosure should be defined as including other embodiments and other examples by the technical spirit of the appended claims and the equivalents to the appended claims.

1. An operation method of a first terminal for automatically enabling a visual audience response system (ARS), comprising:
detecting a user search request for first content;
transmitting a search result request message for the first content to a link information server based on the detected user search request;
receiving search result list information related to the first content from the link information server, the search result list information including uniform resource locator (URL) information for each search result;
displaying a plurality of objects for each search result based on the received search result list information;
detecting a user input for a first object among the plurality of objects; and
making a call connection to a second terminal based on the detected user input,
wherein when the call connection to the second terminal is made, visual VARS related to the second terminal corresponding to the first object is automatically enabled based on the URL information for each search result.

2. The operation method of a first terminal according to claim 1, wherein when the link information server receives the search result request message for the first content from the first terminal, the link information server identifies the search result list information related to the first content based on a database of the link information server, and requests the URL information for each search result to a visual ARS server based on the search result list information, and
the link information server receives the URL information for each search result from the visual ARS server and provides to the first terminal.

3. The operation method of a first terminal according to claim 2, wherein the link information server and the visual ARS server are one service server, and the service server identifies the URL information for each search result based on the search result list information, and provides the first terminal with the URL information for each search result based on the search result list information.

4. The operation method of a first terminal according to claim 2, wherein the first terminal transmits location information of the first terminal to the link information server, and the search result list information is acquired based on the location information of the first terminal.

5. The operation method of a first terminal according to claim 1, wherein whether it is possible to automatically enable the visual ARS is identified for each search result based on the search result list information, and
the URL information is provided to the first terminal for only a search result capable of automatically enabling the visual ARS among the search results.

6. The operation method of a first terminal according to claim 1, wherein the plurality of objects for each search result includes at least one of an object which makes a connection to the second terminal, an object which identifies location information of the second terminal or an object which identifies homepage information of the second terminal.

7. The operation method of a first terminal according to claim 1, wherein when the call connection to the second terminal is made and the visual VARS related to the second terminal corresponding to the first object is automatically enabled based on the URL information for each search result, the call connection to the second terminal is terminated, and the first terminal is connected to the visual VARS server and exchanges information based on the automatically enabled visual VARS.

8. The operation method of a first terminal according to claim 1, wherein the first terminal includes an artificial intelligence module, and the first terminal transmits a request message for registration of the link information server to an artificial intelligence server based on the artificial intelligence module, and
when the first terminal receives capsule information of the link information server from the artificial intelligence server, the first terminal transmits the search result request message for the first content based on the capsule information.

9. (canceled)

10. An operation method of a link information server for performing content search of a first terminal, comprising:
receiving a search result request message for first content from the first terminal;
acquiring search result list information related to the first content based on the search result request message for the first content;
requesting uniform resource locator (URL) information for each search result in the search result list information to a visual audience response system (ARS) server based on the acquired search result list information;
receiving the URL information for each search result from the visual ARS server; and
transmitting the received URL information for each search result to the first terminal.

11. An operation method of a visual audience response system (ARS) server for performing content search of a first terminal, comprising:
receiving a uniform resource locator (URL) information request for each search result in search result list information from a link information server;
identifying whether it is possible to automatically enable visual ARS for each search result in the search result list information;
transmitting the URL information for each search result capable of automatically enabling the visual ARS among the search results in the search result list information to the link information server; and
exchanging data with the first terminal when the first terminal connected to the link information server makes a call connection to a second terminal based on the URL information for each search result.
